(19) United States
(12) Patent Application Publication
(10) Pub. No.: US 2004/0169654 A1
(43) Pub. Date: Sep. 2, 2004

(54) System and method for tree map visualization for database performance data

(75) Inventors: Richard S. Walker, Madison, AL (US); Jack Basiago, Toney, AL (US)

Correspondence Address: LANIER FORD SHAVER & PAYNE, P O BOX 2087, HUNTSVILLE, AL, 35804, US

(73) Assignee: Teracruz, Inc., Madison, AL

(21) Appl. No.: 10/375,393

(22) Filed: Feb. 27, 2003

(51) Int. Cl. G06T 11/20

(52) U.S. Cl. 345/440

(57) ABSTRACT

A tree map visualization for database performance data comprises an observable object of a database system, a hierarchical structure of the database system, the hierarchical structure comprising a database relationship involving the observable object, a first performance metric associated with the observable object, and a second performance metric associated with the observable object, wherein the first performance metric associated with the observable object is represented by the size of a rectangle that represents the observable object and the second performance metric associated with the observable object is represented by a color of the rectangle that represents the observable object.

### BACKGROUND

1. Field

The present invention relates generally to computer networks and computer systems that operate in a networked environment and, in particular, to a system and method for graphically displaying database system performance data.

2. Description of the Related Art

With the continually increasing dependence on data and the importance placed on the ability to efficiently manage the data, database systems are becoming critical components of many computing infrastructures. As such, the database systems' ability to execute and perform at high levels is vital to the efficient management of the data. For example, database systems need to provide fast, efficient, and accurate storage, searching, retrieval, presentation, and other manipulation of data in the database. Typically, these database systems consists primarily of database servers and their coupled networked clients.

To monitor the performance of database systems, performance data is typically collected and analyzed to fine-tune the performance of a database system. Considerable resources are usually employed to bring these database systems up to an acceptable level of performance and to maintain that performance. Tools that give insight into system performance and behavior are therefore quite valuable because they make the necessary performance tuning a more efficient and successful process.

To this end, graphical visualization methods have evolved to assist in the monitoring and performance management of database systems. These methods consist primarily of traditional line graphs, pie charts, bar charts, and the like, which are used to show the value of some performance characteristic or parameter over time. In addition, displays designed to indicate current status have used color-coded icons in an attempt to convey the current overall state of a large collection of managed objects.

One drawback to the existing and conventional methods of displaying and visualizing the performance characteristics of database systems is that they are not readily understandable. These conventional visualization methods fail to present the performance data for easy comprehension and analysis. Users are challenged with the difficult task of arranging, interpreting, analyzing, and processing the displayed performance data in order to enhance the performance of the database systems. This task becomes even more daunting with the increasingly complex and large database systems that are employed today.

### SUMMARY

In one embodiment, a method for tree map visualization of database performance data comprises retrieving user-specified tree map display parameters comprising an object of interest, a hierarchical structure of interest, a first database system performance data associated with the object, and a second database system performance data associated with the object. The method also comprises retrieving from a source of database system performance data a plurality of database system performance data necessary to generate a tree map visualization of the object and the hierarchical structure, and displaying on a display device the tree map visualization, the tree map visualization comprising a plurality of geometric shapes, each geometric shape representing an instance of the object, wherein a dimensional parameter of each geometric shape represents the first database system performance data associated with the object, and a color parameter of each object represents the second database system performance data associated with the object.

In another embodiment, a tree map visualization for database performance data comprises an observable object of a database system, a hierarchical structure of the database system, the hierarchical structure comprising a database relationship involving the observable object, a first performance metric associated with the observable object, and a second performance metric associated with the observable object, wherein the first performance metric associated with the observable object is represented by the size of a rectangle that represents the observable object and the second performance metric associated with the observable object is represented by a color of the rectangle that represents the observable object.

In still another embodiment, a computer-readable storage medium has stored thereon computer instructions that, when executed by a computer, cause the computer to retrieve user-specified tree map display parameters comprising an object of interest, a hierarchical structure of interest, a first performance metric associated with the object, and a second performance metric associated with the object, retrieving a plurality of database system performance data necessary to generate a tree map visualization of the object of interest, the hierarchical structure of interest, the first performance metric associated with the object, and a second performance metric associated with the object, and display on a display device the tree map visualization of the object of interest, the tree map visualization comprising a plurality of rectangles, each rectangle representing an instance of the object and the hierarchical structure, wherein the first performance metric is represented by the size of the rectangle and the second performance metric is represented by the color of the rectangle.

These and other embodiments of the present invention will also become readily apparent to those skilled in the art from the following detailed description of the embodiments having reference to the attached figures, the invention not being limited to any particular embodiment(s) disclosed.

### BRIEF DESCRIPTION OF THE DRAWINGS

The following drawings incorporated in and forming a part of the specification illustrate, and together with the detailed description serve to explain various aspects of the implementation(s) and/or embodiment(s) of the invention and not of the invention itself.

FIG. 1 illustrates a block diagram illustrating an exemplary environment in which a performance data visualization system of the present invention may operate.

FIG. 2 illustrates a block diagram of exemplary components of one embodiment of a performance data visualization system, according to the present invention.

FIG. 3 illustrates a flow chart of one embodiment of a method by which a performance data visualization system monitors and collects database system performance data, according to the present invention.

FIG. 4 is a pictorial representation of storage bins suitable for maintaining statistical records, according to the present invention.

FIG. 5 illustrates a flow chart of one embodiment of a method by which a performance data visualization system displays database system performance data, according to the present invention.

FIG. 6 illustrates a pictorial view of an exemplary tree map visualization of database system performance data, according to the present invention.

FIG. 7 illustrates a pictorial view of another exemplary tree map visualization of database system performance data, according to the present invention.

### DETAILED DESCRIPTION

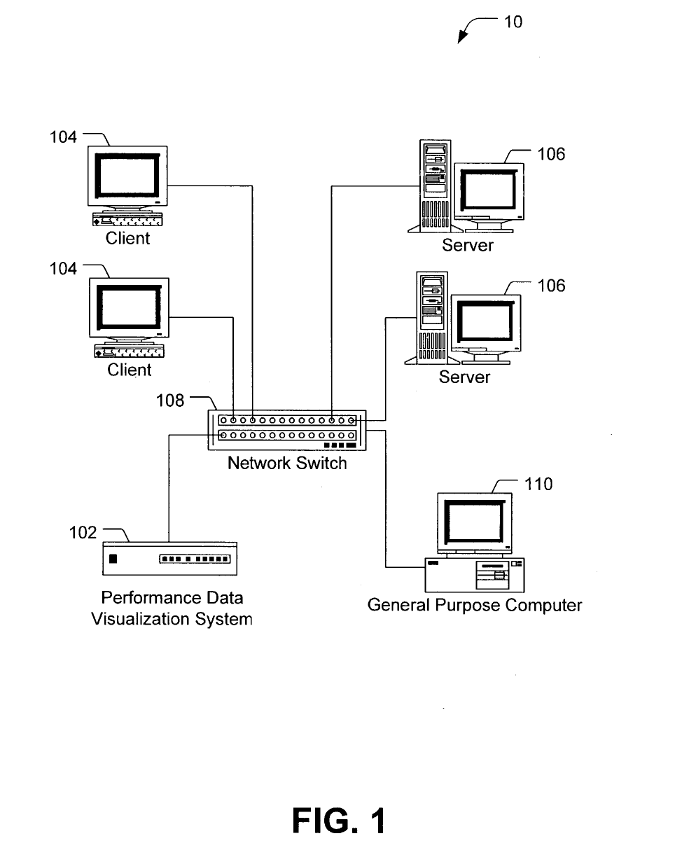

The various embodiments of the present invention and their advantages are best understood by referring to FIGS. 1 through 7 of the drawings. The elements of the drawings are not necessarily to scale, emphasis instead being placed upon clearly illustrating the principles of the invention. Throughout the drawings, like numerals are used for like and corresponding parts of the various drawings.

Turning first to the nomenclature of the specification, at least one embodiment described in the detailed description that follows is presented largely in terms of processes and symbolic representations of operations performed by computers, including computer components. A computer may be any microprocessor or processor (hereinafter referred to as processor) controlled device capable of enabling or performing the processes and functionality set forth herein. The computer may possess input devices such as, by way of example, a keyboard, a keypad, a mouse, a microphone, or a touch screen, and output devices such as a computer screen, printer, or a speaker. Additionally, the computer includes memory such as, without limitation, a memory storage device or an addressable storage medium.

The computer, and the computer memory, may advantageously contain program logic or other substrate configuration representing data and instructions, which cause the computer to operate in a specific and predefined manner as, described herein. The program logic may advantageously be implemented as one or more modules. The modules may advantageously be configured to reside on the computer memory and execute on the one or more processors (i.e., computers). The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro-code, circuitry, data, and the like.

The program logic can be maintained or stored on a computer-readable storage medium. The term “computer-readable storage medium” refers to any medium that participates in providing the symbolic representations of operations to a processor for execution. Such media may take many forms, including, without limitation, volatile memory, nonvolatile memory, flash memory, electronic transmission media, and the like. Volatile memory includes, for example, dynamic memory and cache memory normally present in computers. Nonvolatile memory includes, for example, optical or magnetic disks.

It should also be understood that the programs, modules, processes, methods, and the like, described herein are but exemplary implementations and are not related, or limited, to any particular computer, apparatus, or computer language. Rather, various types of general-purpose computing machines or devices may be used with programs constructed in accordance with the teachings described herein. Similarly, it may prove advantageous to construct a specialized apparatus to perform some or all of the method steps described herein by way of dedicated computer systems with hard-wired logic or programs stored in non-volatile memory, such as, by way of example, read-only memory (ROM).

FIG. 1 illustrates a block diagram illustrating an exemplary environment 10 in which a performance data visualization system 102 of the present invention may operate. In one embodiment, environment 10 comprises a networked database system. The networked database system provides a networked environment in which database clients and database servers can communicate, typically through a hub or network switch.

As depicted, environment 10 comprises performance data visualization system 102, at least one client 104, and at least one server 106 each coupled to a network switch 108. As used herein, the terms “connected,” “coupled,” or any variant thereof, means any connection or coupling, either direct or indirect, between two or more elements; the coupling or connection between the elements can be physical, logical, communicative, or a combination thereof.

In one embodiment, the networked database system comprises a database management system. For example, at least one server 106 can host the database management system server software, and a user can execute a database client software on a client 104 to interact with the database management system. Network switch 108 generally functions to provide the interconnection for the networked database system infrastructure. Even though each client 104 and server 106 is shown coupled to the same network switch 108, it is appreciated that a client 104 that is coupled to a different hub or network switch can communicate with the networked database system and, in particular, the database management system executing within the database network computer system.

Typically, and as is generally known, information is exchanged between database clients (i.e., client 104) and database servers (i.e., server 106) based on relationships that are configured by a network or database system administrator. For example, the database system administrator builds a database system with computer hardware and software that is optimized at various levels within the database system. Accordingly, the database client and server hardware and software may be different to meet desired performance criteria while maintaining costs. These differences are implemented on a homogeneous network, but clients and servers are configured to implement or achieve client/server pairings (i.e., client-server relationships). Once the database system administrator determines the client/server pairings that satisfy the desired requirements, the database system administrator configures these relationships by “pointing” clients to servers using client configuration files.

Performance data visualization system 102 implements and incorporates the various aspects of the present invention. In particular, one or more software components or programs that embody the various aspects of the present invention execute on performance data visualization system 102. In one embodiment, performance data visualization system 102 generally functions to inspect the network packets, determine if the network packets are relevant for gathering database system performance statistics, store and update relevant database system performance data, and make accessible the database system performance data through a tree map visualization of the performance data.

Performance data visualization system 102 requires a network infrastructure that provides the desired client/server network traffic to be copied and/or directed to performance data visualization system 102. As is known, conventional hub devices can be configured to automatically route port traffic at one port to all the other ports on the hub. Accordingly, network switch 108 is configured to enable performance data visualization system 102 to receive the desired client/server network traffic. Stated another way, network switch 108 is configured such that the desired port traffic is mirrored or copied to the port that is connected to performance data visualization system 102.

Performance data visualization system 102 may or may not have input/output ports suitable for connecting devices such as, by way of example, a keyboard, a mouse, and/or a video device. Typically, and as depicted in FIG. 1, performance data visualization system 102 does not have input/output ports for connecting such input/output devices because large enterprise computer systems are implemented in rack-mount configurations, and in these configurations it is advantageous to share keyboard/video resources to conserve space. Here, performance data visualization system 102 can transmit the database system performance data to a coupled remote device, such as a general-purpose computer 110, for display as a tree map visualization on general-purpose computer 110.

In one embodiment, performance data visualization system 102 supports network connectivity through an Internet Protocol (IP) address. A user can then execute an Internet browser or other suitable client software on general-purpose computer 110 to access the IP address of performance data visualization system 102. Once accessed, performance data visualization system 102 detects whether the browser software executing on general-purpose computer 110 supports the Java™ run-time environment. If the Java™ run-time environment is not supported performance data visualization system 102 requests that the user downloads the Java™ run-time environment before accessing performance data visualization system 102.

If the Internet browser executing on general-purpose computer 110 supports the Java™ run-time environment, performance data visualization system 102 downloads a Java panel onto general-purpose computer 110 for execution on general-purpose computer 110. The Java™ panel is an implementation of the client software that generally functions to authenticate a user, request and receive user requested database system performance data from performance data visualization system 102, and render a tree map visualization of the performance data. It is appreciated that the client software need not be implemented as a Java™ panel but can also be implemented using other generally known programming languages and techniques.

As depicted in FIG. 1, general-purpose computer 110 is coupled to network switch 108. In addition to displaying a tree map visualization of performance data, a database system administrator can use general-purpose computer 110 to configure and manage the database network computer system and, in particular, network switch 108 as is generally known to one of ordinary skill in the art. The database system administrator can also use general-purpose computer 110, or another suitable computing device (not shown), to configure performance data visualization system 102 to gather or generate certain types of database system performance data and/or statistics. The types of database system performance data are further described below.

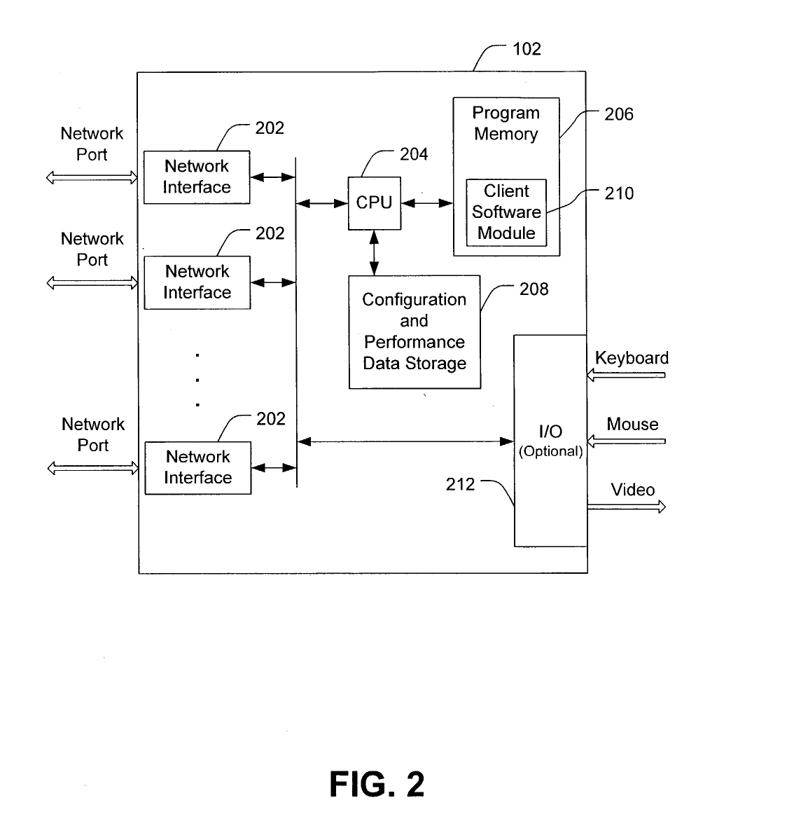

FIG. 2 illustrates a block diagram of exemplary components of one embodiment of performance data visualization system 102, according to the present invention. Performance data visualization system 102 comprises at least one network interface 202 coupled to a central processing unit (CPU) 204. Each network interface 202 supports and functions as a network port.

In one embodiment, the network ports are Ethernet ports and network interfaces 202 are essentially subsystems that comprise a connector, interface electronics, a network Media Access Controller (MAC), and a network PHY module or chip that interfaces the wire to the MAC (the PHY module makes the signal on the physical wire understandable to the MAC, and visa versa). Typically, network interface 202, including most of the aforementioned components comprising network interface 202 is embodied in what is generally referred to as an Ethernet Controller. In one embodiment, the Ethernet Controller comprises Ethernet software, which is implemented using Linux Ethernet drivers. It is appreciated that network interface 202 can support other types of network ports, such as, by way of example and not limitation, FibreChannel, Infiniband, and FDDI.

Typically, the network controller (i.e., network interface 202) also comprises a Direct Memory Access Controller (DMAC) that is programmed to deliver received network packets directly from the network port (i.e., Ethernet port) to memory. The network controller vendor usually delivers the network controller in the form of an operating system network interface driver. The driver software configures the network controller to receive and send network packets, store received packets directly into memory, and transmit packets by configuring the internal DMAC to retrieve network packets directly from memory for transmission by the network controller.

CPU 204 is the controlling center for performance data visualization system 102 and generally functions to provide conventional processing facilities for initial program loading, program instruction execution, interrupt processing, timing functions, and other machine and computer-related functions. In one embodiment, CPU 204 executes the Linux operating system, which is used to control the operation of the computing environment within performance data visualization system 102 by controlling the execution of programs (including communication protocols), controlling communication with network interfaces 202, controlling communication with peripheral devices, and controlling the use of performance data visualization system 102 resources.

As depicted in FIG. 2, performance data visualization system 102 also comprises a program memory 206 and a configuration and performance data storage 208 each coupled to CPU 204. Program memory 206 and configuration and performance data storage 208 are computer-readable storage media. In one embodiment, program memory 206 is implemented as a flash module, which is programmed with software that enables performance data visualization system 102 to function as disclosed herein.

Program memory 206 comprises client software module 210. In one embodiment, client software module 210 is the aforementioned Java™ panel that is downloaded onto and executed on a remote computer. When executed, client software module 210 allows a user at the remote computer to connect to performance data visualization system 102 and specify user configuration data, request and receive user requested database system performance data, and render a tree map visualization of the performance data. In this embodiment, performance data visualization system 102 provides web-server or other network-server software that allows the remote computer to connect to and interact with performance data visualization system 102.

In another embodiment, client software module 210 is a client program that is executed on performance data visualization system 102, for example, by CPU 204. For example, a user can use a terminal-like device that is coupled to performance data visualization system 102 and execute client software module 210 to specify user configuration data and render a tree map visualization of database system performance data of interest to the user.

In one embodiment, configuration and performance data storage 208 is implemented as random access memory (RAM) and generally functions to maintain data within performance data visualization system 102. Examples of such data include, without limitation, variables used by the operating system, network packets, user configuration information, and database system performance data and statistics.

Also coupled to CPU 204 is an I/O 212. I/O 212 is optional, and generally functions to provide connectivity to peripheral devices such as a keyboard, a mouse, and/or audio/video devices. For example, a user may connect a terminal to I/O 212 and access and execute programs on performance data visualization system 102, including client software module 210.

The aforementioned components of performance data visualization system 102 are only illustrative and performance data visualization system 102 may comprise other components and modules not depicted. The depicted components and modules may communicate with each other and other components comprising performance data visualization system 102 through mechanisms such as, by way of example, direct memory access, interprocess communication, procedure and function calls, application program interfaces, other various program interfaces, and various network protocols. Furthermore, the functionality provided for in the components and modules may be combined into fewer components or modules or further separated into additional components or modules.

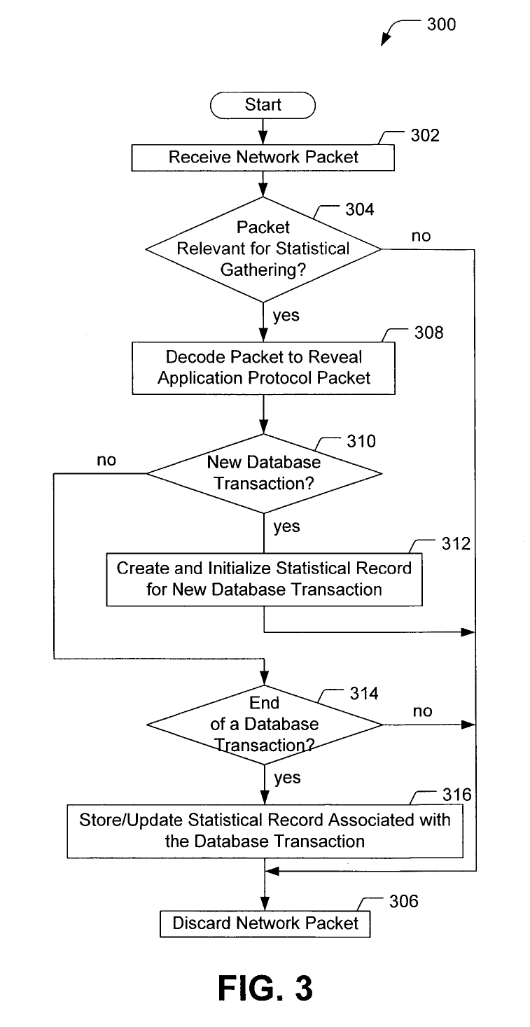

FIG. 3 illustrates a flow chart of one embodiment of a method 300 by which performance data visualization system 102 monitors and collects database system performance data, according to the present invention. Beginning at a start step, an administrator configures network switch 108 to route network packets (i.e., network information) of interest to the coupled performance data visualization system 102. For example, the administrator can configure network switch 108 to mirror or duplicate network packets addressed to or originating from one or more database servers to performance data visualization system 102.

For ease and clarity of explanation, it is assumed that the network packets of interest are Ethernet packets and that a higher-level Transmission Control Protocol/Internet Protocol (TCP/IP) exists on top of the physical and data link layers in the Ethernet Packets. Moreover, the application is a database application and, accordingly, the application protocol is a predefined application protocol that is used by the database servers and clients to interact with each other. Thus, in one embodiment, program memory 206 (FIG. 2) comprises software programs which implement the relevant database application protocol to enable performance data visualization system 102 to process the received network packets. Moreover, program memory 206 can also comprise software programs that implement TCP/IP if the resident operating system does not provide and/or support TCP/IP.

At a step 302, performance data visualization system 102 receives a network packet. Various components of performance data visualization system 102 (i.e., network interface 202, the resident operating system, etc.) process the received network packet to determine if the network packet is relevant for statistical gathering. This typically involves decoding one or more lower level protocols encoded in the network packet. For example, certain types of network packets, such as, by way of example, status packets, low layer communication packets, and the like, may not be necessary for statistical gathering.

At step 304, performance data visualization system 102 determines whether the received network packet is relevant for statistical gathering. If the network packet is not relevant, performance data visualization system 102 discards the network packet at step 306 and waits to receive another network packet. Otherwise, at step 308, performance data visualization system 102 decodes the network packet to reveal the application protocol packet. For example, the resident operating system can process the network packet to reveal the database application protocol packet encoded within the network packet.

At step 310, performance data visualization system 102 processes the database application packet to determine whether the database application packet signifies or signals a new database transaction. Typically, the ordering of database transactions or requests by a particular database client is generally serial in nature. For example, when a client makes a request to the database, the client waits for the database server to respond. The same client does not make a second request until its first request is completed, either successfully or unsuccessfully. Therefore, performance data visualization system 102 can determine whether the database application packet is a request for a new database transaction.

If, at step 310, performance data visualization system 102 determines that the database application packet signifies a new database transaction, performance data visualization system 102 creates and initializes a statistical record for the new database transaction in, for example, configuration and performance data storage 208 at step 312. Performance data visualization system 102 stores and maintains information regarding the database transaction, such as, by way of example and not limitation, user name, client name, database server name, database name, type of database transaction (select, update, insert, etc), size of database transaction, database table information, database record information, and any necessary timing parameters, in the associated statistical record.

It is appreciated that one or more items of information regarding the database transaction may not be contained in or discernable from the presently processed database application packet. For example, the size of the database transaction or the time required to perform the database transaction may not be discernable until one or more subsequent database application packets associated with the current database transaction have been processed. Thus, performance data visualization system 102 discerns the various items of information regarding the database transaction as it processes the network packets associated with the database transaction.

Subsequent to processing the current database application packet to discern the relevant database transaction information that is discernable from the current database application packet and appropriately storing this information in the corresponding statistical record, performance data visualization system 102 discards the database application packet at step 306.

If, at step 310, performance data visualization system 102 determines that the database application packet does not signify a new database transaction, performance data visualization system 102 determines whether the database application packet signifies an end of a presently current database transaction at step 314. If the database application packet signifies an end of a presently current database transaction, performance data visualization system 102 identifies the relevant database transaction and its associated statistical record, and stores and updates the information associated with the identified database transaction in the statistical record. For example, performance data visualization system 102 may calculate the transaction time and store the transaction time in the statistical record.

Subsequent to storing the information regarding the identified database transaction, or determining that the database application packet does not signify an end of a presently current database transaction (step 314), performance data visualization system 102 discards the database application packet at step 306. In another embodiment, performance data visualization system 102 may process database application packets that do not signify a start or an end of a database transaction, for example, to discern one or more items of information related to the corresponding database transaction.

In the embodiment of method 300 mentioned above, to facilitate the explanation of statistical gathering, the monitored network packets were database protocol packets transmitted using the TCP/IP protocol and Ethernet. However, it is appreciated that performance data visualization system 102 is not restricted to the aforementioned protocols, and can readily be programmed to gather statistical information by monitoring different network packets (e.g., token ring packets, FDDI packets, etc.), different higher-level protocols (e.g., system network architecture (SNA), sequenced packet exchange (SPX), etc.), and different application protocol packets (e.g., various different databases, file transfer applications, web server applications, various other client-server applications, etc.).

Those of ordinary skill in the art will appreciate that, for this and other methods disclosed herein, the functions performed in the exemplary flow charts may be implemented in differing order. Furthermore, steps outlined in the flow charts are only exemplary, and some of the steps may be optional, combined into fewer steps, or expanded into additional steps without detracting from the essence of the invention.

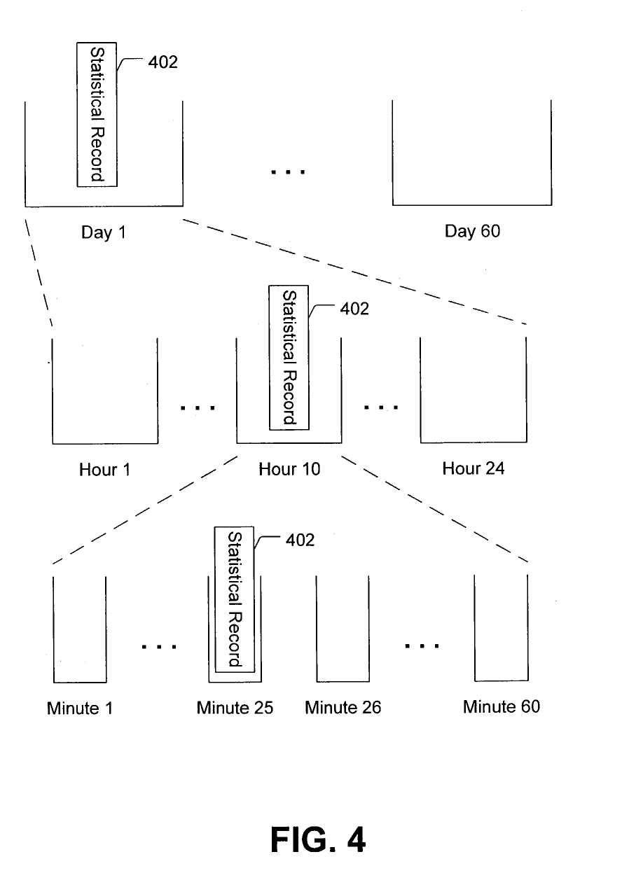

In general, database system performance data is time sensitive. Stated another way, a user, such as a database administrator, is interested in the time nature of database traffic and the performance parameters. Accordingly, in one embodiment, performance data visualization system 102 stores the statistical records containing the database transaction performance data in storage bins. FIG. 4 is a pictorial representation of storage bins suitable for maintaining statistical records, according to the present invention. These storage bins are maintained in configuration and performance data storage 208.

As depicted in FIG. 4, there are sixty one-day storage bins, twenty-four one-hour storage bins, and sixty one-minute storage bins. The sixty one-day storage bins are used to maintain a sixty day history of the database system performance data, the twenty-four one hour storage bins are used to maintain a twenty-four hour (or one day) history of the database system performance data, and the sixty one-minute storage bins are used to maintain a one hour history of the database system performance data.

Performance data visualization system 102 designates one of each type of storage bins (one-day, one-hour, and one-minute) as an active storage bin based on the current day and time-of-day, and stores the database system performance data for the monitored database transactions (i.e., statistical records) in the active storage bins. Stated another way, each active storage bin (i.e., the active one-day storage bin, the active one-hour storage bin, and the active one-minute storage bin) receives the information gathered for each monitored database transaction.

In one embodiment, the active one-day storage bin is associated with the twenty-four one-hour storage bins. Amongst the twenty-four one hour storage bins, the active one-hour storage bin is associated with the sixty one-minute storage bins, including the active one-minute storage bin. For example and as depicted in FIG. 4, assuming that it is presently the twenty-fifth minute of the tenth hour of the first day, performance data visualization system 102 designates the “day 1” one-day storage bin, the “hour 10” one-hour storage bin, and the “minute 25” one-minute storage bin as active storage bins. Assuming further that performance data visualization system 102 just completed gathering the information regarding a database transaction in a statistical record 402, performance data visualization system 102 stores statistical record 402 into each of the active storage bins as depicted in FIG. 4.

The next minute (i.e., twenty-sixth minute), a “minute 26” one-minute storage bin becomes the active one-minute storage bin, and performance data visualization system 102 stores all the database transaction information gathered during this one-minute time period into the “minute 26” one-minute storage bin as well as the “hour 10” one-hour storage bin and the “day 1” one-day storage bin. In this manner, performance data visualization system 102 stores subsequent database transaction information in all the active storage bins based on the current time.

Performance data visualization system 102 uses the storage bins to maintain a “running average” of database transaction statistical information over the respective time frames. The database system performance data in each storage bin (i.e., time period associated with the storage bin) are stored as totals. For example, performance data visualization system 102 can identify each database transaction by access type, client name, user name, and database name. Having knowledge of this information, performance data visualization system 102 can maintain a “running average” or total of the database transaction response times, as well as other relevant database system performance data, by access type, client name, user name, and database name. By storing and maintaining a “running average” of database transaction statistical information in the various storage bins, a user can configure performance data visualization system 102 to display an average of various performance parameters (e.g., average response times) over a particular time period (i.e., any number of minutes, hours, or days).

It is appreciated that the actual number and types of storage bins are not essential, and a different number of stage bins and/or different types of storage bins, including various different methods of maintaining the statistical information in the storage bins can be used while still maintaining the spirit and scope of the invention.

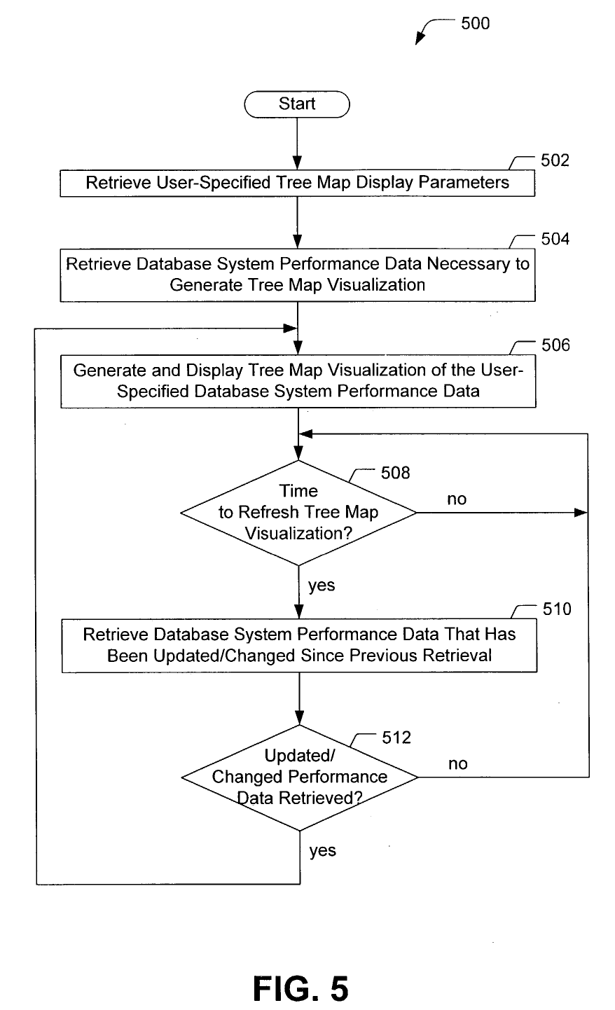

FIG. 5 illustrates a flow chart of one embodiment of a method 500 by which performance data visualization system 102 displays database system performance data, according to the present invention. A user can access performance data visualization system 102 via a video display directly coupled to performance data visualization system 102 or a remote computer, such as, by way of example and not limitation, general-purpose computer 110. For ease and clarity of explanation, it is assumed that the user uses general-purpose computer 110 to access performance data visualization system 102.

Here, the user can execute a readily available browser program on general-purpose computer 110 and “point” the browser to the IP address of performance data visualization system 102. Performance data visualization system 102 then downloads and executes a client software program (i.e., client software module 210) on general-purpose computer 110. The client software program prompts the user for a username and password. Upon receiving a username and password and validating the user, the client software program displays a user interface, through which the user specifies tree map display parameters that are used to generate a tree map visualization and views the tree map visualization of the user-specified database system performance data.

Tree maps can be used to map any two parameters on any hierarchical structure, where the first parameter is mapped as a dimensional parameter (i.e., size of a displayed object, such as a rectangle) and the second parameter is mapped as a color parameter (i.e., the color of the displayed object). One example of a hierarchical structure for a networked database system is composed of the servers at the top of the hierarchical structure. Below the servers are the databases on the servers, and below the databases are the tables on the databases, and finally the tables themselves. The hierarchical structure can also identify the user that accessed the databases (i.e., the users can be positioned below the databases) along with the tables that were accessed by the users. Other relationships in the hierarchical structure can illustrate how database clients and servers exchange information on the networked database system.

Returning to method 500, during a start step, the user specifies the tree map display parameters using the displayed user interface. Tree map display parameters include, without limitation, a refresh time parameter, a statistics time duration parameter, and a color palette. The refresh time parameter designates the frequency with which the client software program receives updated or changed database system performance data of interest to the user from performance data visualization system 102 in order to “refresh” the displayed tree map visualization. The statistics time duration parameter designates the time period for averaging the database system performance data that is of interest to the user. The color palette designates the shades or intensity of one or more colors to use in representing the color parameter in the tree map visualization.

The user also uses the user interface to specify the database system performance data that are of interest to the user as part of the tree map display parameters, including an observable object of interest, the hierarchical structure of interest, and specifying the database system performance data (i.e., performance metric) to represent as the dimensional parameter and the database system performance data to represent as the color parameter. The observable object is further discussed below. In another embodiment, the user can specify a plurality of hierarchical structures to display in the tree map visualization.

As an example, the user may be interested in only the information exchange between a particular database server and all clients (the observable object of interest) that request information/responses from the specified database server and, in particular, the number of queries made by each database client and the database server's average query response time for each database client. Moreover, the user may have specified that the number of queries made by each database client is to be the dimensional parameter and that the database server's average query response time for each database client is to be the color parameter.

In this instance, the hierarchy is the particular database server and the database clients that made queries (i.e., information requests/stores) to the specified database server. Each geometric shape in the tree map represents a database client (i.e., an instance of the object). The size of each geometric shape represents the number of queries made by its respective object (i.e., database client) while the color of each geometric shape represents the average query response time for the respective object.

At a step 502, the client software program retrieves the user-specified tree map display parameters. The client software program uses the retrieved parameters to determine the structure of the tree map and the database system performance data needed to generate the tree map visualization.

At a step 504, the client software program retrieves the database system performance data that is necessary to generate the tree map from performance data visualization system 102, the source of the database system performance data. In particular, the client software program retrieves the database system performance data for a particular time period as determined from the user specified statistics time duration parameter (the time duration parameter specifies the time period of statistical gathering of interest to the user).

Continuing the above example, the user may have specified in the statistics time duration parameter that the user is interested in viewing the number of queries made by each client and the average response time for the queries made by each client over the most recent twenty-four hour period. In this instance, the client software program will request this information from performance data visualization system 102. In response, performance data visualization system 102 can retrieve the requested information from one or more of the storage bins it uses to store the database system performance data, perform any required averaging operation, and transmit the requested information to the client software program.

At step 506, the client software program generates and displays a tree map visualization of the user-specified database system performance data on general-purpose computer 110. Continuing the above example, the client software program can determine the total number of queries made by all the clients and designate this as the total area of the rectangles. The client software program can then determine a size of a rectangle for each client, where the size of each rectangle represents the number of queries made by the respective client. The size of each rectangle is proportional to the sizes of each of the other rectangles according to the number of queries represented by each of the rectangles. Stated another way, the size of a particular rectangle is proportional to the total area of the rectangles based on the ratio of the number of queries represented by the particular rectangle and the total number of queries.

The client software program can then color each rectangle according to the user-specified color palette to represent the average response time for the queries made by each client. Assuming the user specified the color red, the client software program can color each rectangle with a different shade or brightness of red, where a brighter shade of red designates slower response time compared to a duller or less bright shade of red which represents a faster response time.

At a step 508, the client software program determines whether it is time to refresh the tree map visualization. The frequency with which to refresh the tree map visualization is determined from the refresh time parameter. If the client software program determines it is not time to refresh the tree map visualization, the client software program continues to wait until it is time to refresh the tree map visualization.

Otherwise, if it is time to refresh the tree map visualization, the client software program, at step 510, retrieves the database system performance data that has been updated/changed since the previous retrieval. At step 512, the client software program determines whether it has retrieved any updated/changed database system performance data. If it has not retrieved any updated/changed database system performance data, the client software program proceeds to step 508 to determine whether it is time to refresh the tree map visualization.

If, at step 512, the client software program determines that it has retrieved updated/changed database system performance data, the client software program proceeds to step 506 to update the tree map visualization. In this manner, the client software program dynamically updates the tree map visualization to reflect current or up-to-date database system performance data that is of interest to the user.

It is appreciated that the user can change any of the tree map display parameters using the displayed user interface. The client software program detects any change to the tree map display parameters and accordingly updates the displayed tree map visualization. Furthermore, the user can terminate the displayed tree map visualization by, for example, a terminate option provided in the user interface.

In one embodiment, the client software program displays one or more symbols to indicate additional status information or as a prompt for the user to “click” in order to access more extensive information of a displayed object (i.e., rectangle). For example, when a user clicks on a displayed rectangle, the client software program can display a window that contains detailed performance data for the associated object. In another embodiment, the client software program can animate the tree map visualization to show how the historical parameter values (the database system performance data) changed over time.

A technical advantage of the tree-map visualization is that it is animated and changes in “real time” as performance data is averaged over a user-specified time period. The client software program provides to the user great flexibility in specifying the resolution of the tree map visualization and the time period of interest. For example the user can specify one-minute resolution (in the refresh time parameter) of the desired performance data averaged over a sixty-minute or one hour period (in the statistics time duration parameter). Or, the user can specify a one-hour resolution with the desired performance data averaged over the last twenty-four hour period including the current one-hour window. The user can also specify a time period that starts with a beginning time that has past to view historical performance data.

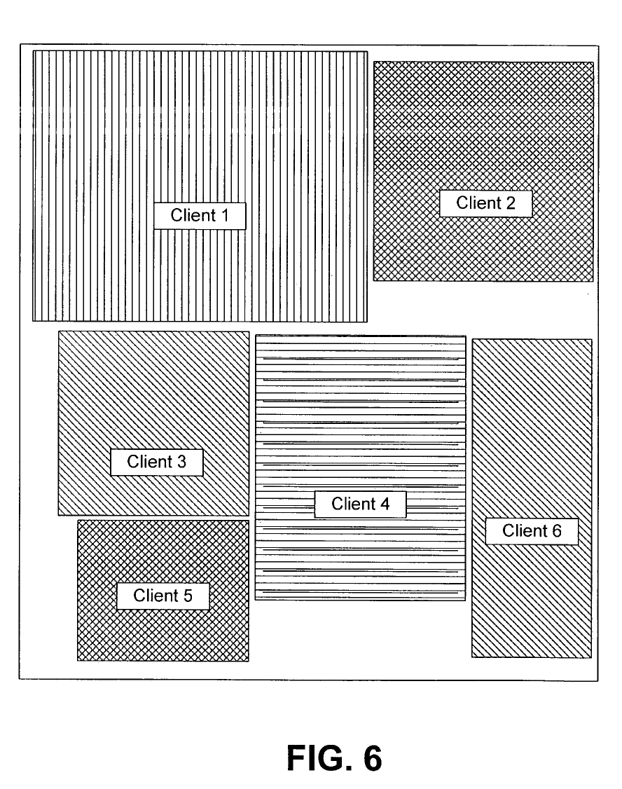

FIG. 6 illustrates a pictorial view of an exemplary tree map visualization of database system performance data, according to the present invention. This tree map visualization display is composed of a collection of rectangles, each of which represents some observable object, such as, by way of example and not limitation, a database instance, database server, database query, database client, database table, and the like. The size or area of the rectangle is proportional to some parameter or performance metric associated with the object, such as, by way of example, a number of queries against a database. Each rectangle is dynamically colored to reflect the value of some other parameter or performance metric associated with the object, typically a parameter of a more dynamic nature (i.e., time-based), such as, by way of example, a query response time. A technical advantage to the tree map visualization is that it imparts an overall sense of the state of the database system because the importance of the colorized parameter's values is weighted by the area of the parameter's values.

For example, FIG. 6 depicts a single hierarchical structure between the database system and the database clients. In particular, each rectangle represents a database client (the observable object) and the collection of the database clients compose an entire object set. The size of each rectangle represents the number of queries made by each client, and the color (represented by hatching in the figure) of the rectangle represents the average query response time for the respective client.

In one embodiment, the average query response time may be visually depicted using a plurality of colors. A first color, such as green, can represent adequate or good response times, while a second color, such as red, can represent inadequate or poor response times. Additionally, the intensity of the color can represent the degree to which the response time is either good or poor. For example, brighter shades of green represent better response times than a duller shade of green. Conversely, a brighter shade of red represent slower response times than a duller shade of red.

In FIG. 6, the tree map visualization conveys that “client 2” has made the larger number of queries, and that “client 5” has made the fewest number of queries. furthermore, “client 2” and “client 5” have the best average response times as indicated by the bright shade of green (represented by diagonal cross-hatching), while “client 1” had the poorest average response time as indicated by the bright shade of red (represented by vertical hatching). Furthermore, “client 3” and “client 6” have good average response times as indicated by a duller shade of green (represented by diagonal hatching) and “client 4” has a poor but better average response time than “client 1.” as indicated by a duller shade of red (represented by horizontal hatching).

The following table lists examples of possible applications for tree map visualizations for database performance monitoring. The listed objects and parameters are only examples and not intended to be exhaustive or complete.

| | Area-Proportional | |
|---|---|---|
| Rectangle Object | Parameter | Color Proportional Parameter |
| Database Instance | Number of Queries | Average Query Response Time |
| Database Instance | Size of Database | Number of Queries |
| Database Server | Number of Queries | Average Query Response Time |
| Database Query | Number of Rows | Average Query Response Time |
| | Returned | |
| Database Client | Number of Queries | Average Query Response Time |
| Database Table | Number of Queries | Number of Rows Returned |
| Database Server | Queries Against | Queries Answered |
| Database Server | Outstanding Queries | Average Waiting Time |

In certain instances, the client software program may not display a name of an observable object (i.e., “client 1” , etc.), for example, if the object is too small. The client software program provides the user a command or option to view the name of the object. For example, the user can position a cursor over the object to display the name of the object.

The client software program can also display a window that lists additional parameters or metrics the user can request to display regarding the object. For example, the user can position and double-click on an object to view additional and more detailed information about the object.

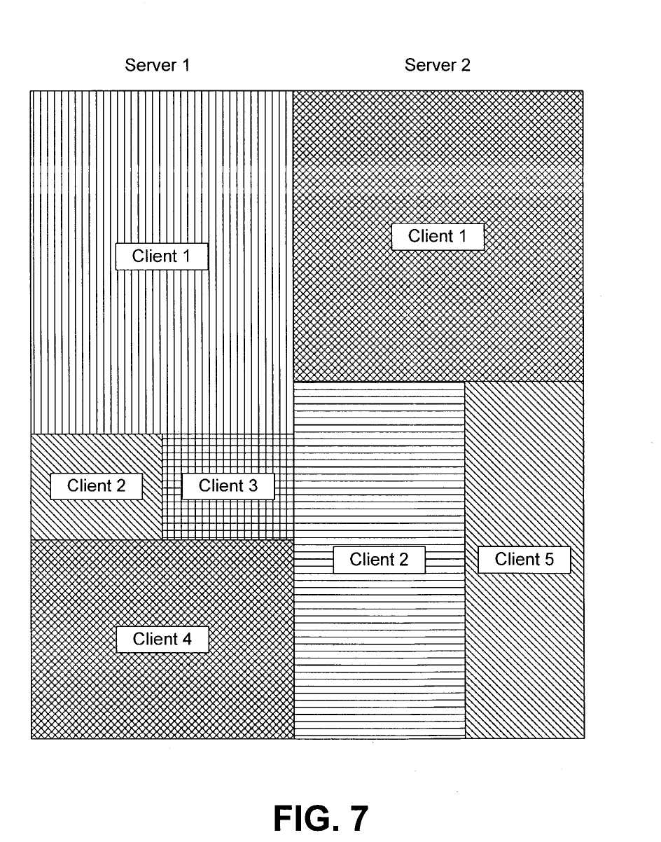

FIG. 7 illustrates a pictorial view of another exemplary tree map visualization of database system performance data, according to the present invention. The tree map visualization depicts a plurality of hierarchical structures. In particular, a tree map visualization for a database system composed of two database servers is shown. As depicted, a first hierarchical structure or grouping depicts a relationship of database clients to a first database server (“server 1”), and a second hierarchical structure or grouping depicts a relationship of database clients to a second database server (“server 2”). The size and color of each object is relative to the size and color of objects in both the first grouping and the second grouping. Thus, a user can easily access the performance of the database servers in the database system in relation to each other, as well as the performance of the various depicted clients.

While certain embodiments of the invention have been described, these embodiments have been presented by way of example only, and are not intended to limit the scope of the present invention. For example, although the present invention has been described with reference to networked database systems, it should be recognized the invention is not so limited, and that the various aspects of the invention can be readily applied to non-networked database systems, as well as to other application systems to which performance is an issue.

Accordingly, this invention may be provided in other specific forms and embodiments without departing from the essential characteristics as described herein. The embodiments described above are to be considered in all aspects as illustrative only and not restrictive in any manner. The following claims rather than the foregoing description indicate the scope of the invention.

What is claimed is:

1. A method for tree map visualization of database performance data comprising:
retrieving user-specified tree map display parameters comprising an object of interest, a hierarchical structure of interest, a first database system performance data associated with the object, and a second database system performance data associated with the object;
retrieving from a source of database system performance data a plurality of database system performance data necessary to generate a tree map visualization of the object and the hierarchical structure; and
displaying on a display device the tree map visualization, the tree map visualization comprising a plurality of geometric shapes, each geometric shape representing an instance of the object;
wherein a dimensional parameter of each geometric shape represents the first database system performance data associated with the object, and a color parameter of each object represents the second database system performance data associated with the object.

2. The method of claim 1, wherein the user-specified tree map display parameters comprises a plurality of hierarchical structures of interest.

3. The method of claim 1, wherein the object of interest is a database instance.

4. The method of claim 1, wherein the object of interest is a database server.

5. The method of claim 1, wherein the object of interest is a database query.

6. The method of claim 1, wherein the object of interest is a database table.

7. The method of claim 1 further comprising:
determining whether it is time to refresh the tree map visualization of the object and the hierarchical structure;
responsive to determining that it is time to refresh the tree map visualization of the object and the hierarchical structure; retrieving database system performance data that has been updated or changed since the previous retrieving step; and
updating the tree map visualization of the object and the hierarchical structure.

8. A tree map visualization for database performance data comprising:
an observable object of a database system;
a hierarchical structure of the database system, the hierarchical structure comprising a database relationship involving the observable object;
a first performance metric associated with the observable object; and
a second performance metric associated with the observable object;
wherein the first performance metric associated with the observable object is represented by the size of a rectangle that represents the observable object and the second performance metric associated with the observable object is represented by a color of the rectangle that represents the observable object.

9. The tree map visualization of claim 8, wherein the second performance metric is a time-based parameter.

10. The tree map visualization of claim 8, wherein a plurality of colors represent the second performance metric associated with the observable object.

11. The tree map visualization of claim 8, wherein an intensity of the color represents a degree of the second performance metric associated with the observable object.

12. The tree map visualization of claim 8, wherein the tree map visualization is animated to illustrate change in the first performance metric and the second performance metric over time.

13. The tree map visualization of claim 8, wherein the first performance metric is an average over a time period.

14. The tree map visualization of claim 8, wherein the second performance metric is an average over a time period.

15. A computer-readable storage medium having stored thereon computer instructions that, when executed by a computer, cause the computer to:
retrieve user-specified tree map display parameters comprising an object of interest, a hierarchical structure of interest, a first performance metric associated with the object, and a second performance metric associated with the object;
retrieving a plurality of database system performance data necessary to generate a tree map visualization of the object of interest, the hierarchical structure of interest, the first performance metric associated with the object, and a second performance metric associated with the object; and
display on a display device the tree map visualization of the object of interest, the tree map visualization comprising a plurality of rectangles, each rectangle representing an instance of the object and the hierarchical structure;
wherein the first performance metric is represented by the size of the rectangle and the second performance metric is represented by the color of the rectangle.

16. The computer-readable storage medium of claim 15, wherein the second performance metric is represented by a plurality of colors.

17. The computer-readable storage medium of claim 15 further comprising computer instructions that, when executed by a computer, cause the computer to animate the tree map visualization to show how the first and second performance metrics changed over time.

18. The computer-readable storage medium of claim 15 further comprising computer instructions that, when executed by a computer, cause the computer to:
retrieve at least one item of database system performance data that has been updated or changed; and
update the tree map visualization to reflect the at least the one item of database system performance data that has been updated or changed

19. The computer-readable storage medium of claim 15, wherein the second performance metric indicates a time value.

20. The computer-readable storage medium of claim 15, wherein the user-specified tree map display parameters further comprise a refresh time parameter.
